(19) United States
(12) Patent Application Publication
(10) Pub. No.: US 2026/0113420 A1
(43) Pub. Date: Apr. 23, 2026

(54) MINI-LIGHT EMITTING DIODE (LED) LIGHT SOURCE AND LIQUID CRYSTAL ON SILICON (LCOS) DISPLAY

(71) Applicant: Meta Platforms Technologies, LLC, Menlo Park, CA (US)

(72) Inventors: Qian Zhao, San Jose, CA (US); Fei Chen, Wellesley, MA (US); Bing Chen, Redmond, WA (US); Ying-Lan Chang, CUPERTINO, CA (US)

(21) Appl. No.: 18/924,170

(22) Filed: Oct. 23, 2024

(51) Int. Cl. H04N 9/31; G02F 1/1335

(52) U.S. Cl. CPC H04N 9/317; G02F 1/133616; H04N 9/3108; H04N 9/3152; H04N 9/3155; H04N 9/3164; H04N 9/3167; H04N 9/3173

(57) ABSTRACT

A light source for a display includes a driver substrate, an array of mini-LEDs, and a metalens. The driver substrate is configured to selectively illuminate mini-LEDs in the array to generate illumination light. The metalens is configured to focus the illumination light as focused illumination light. The light source may provide illumination light to a Liquid Crystal on Silicon (LCOS) display.

### TECHNICAL FIELD

This disclosure relates generally to optics, and in particular to displays.

### BACKGROUND INFORMATION

Modern display technologies include liquid crystal displays (LCD) panels, projectors, organic light emitting diode (OLED) arrays, Liquid Crystal on Silicon (LCOS) displays, and even transparent displays. Common performance metrics of displays include brightness and contrast measurements. Certain display technologies are better suited for different contexts based on size, power, and desirable performance metrics. Brightness uniformity and color uniformity are important performance metrics, in some contexts. Contrast ratio may also be an important performance metric.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 illustrates a head mounted display (HMD) that may include an LCOS display system including a light source, in accordance with aspects of the disclosure.

FIG. 2 illustrates an example LCOS system having a conventional illumination system.

FIG. 3 illustrates an example LCOS system including an illumination system, in accordance with aspects of the disclosure.

FIG. 4 illustrates an example arrangement of an array of mini-LEDs included in a light source for an LCOS display, in accordance with aspects of the disclosure.

FIG. 5 illustrates an example arrangement of an array of mini-LEDs included in a light source for an LCOS display, in accordance with aspects of the disclosure.

FIG. 6A illustrates a side view of a structure including an array of mini-LEDs disposed on a driver substrate, in accordance with aspects of the disclosure.

FIG. 6B illustrates a side view of a structure including an array of mini-LEDs disposed on a driver substrate, in accordance with aspects of the disclosure.

FIG. 7A illustrates an example illumination system including a driver substrate, a mini-LED array, an optional direction layer, and a metalens, in accordance with aspects of the disclosure.

FIG. 7B shows an exploded view of the illumination system of FIG. 7A, in accordance with aspects of the disclosure.

FIG. 8A-8E show example optical functionality that may be written into a metalenses, in accordance with aspects of the disclosure.

### DETAILED DESCRIPTION

Embodiments of mini-LED light sources and LCOS displays are described herein. In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In some implementations of the disclosure, the term “near-eye” may be defined as including an element that is configured to be placed within 50 mm of an eye of a user while a near-eye device is being utilized. Therefore, a “near-eye optical element” or a “near-eye system” would include one or more elements configured to be placed within 50 mm of the eye of the user.

In aspects of this disclosure, visible light may be defined as having a wavelength range of approximately 380 nm-700 nm. Non-visible light may be defined as light having wavelengths that are outside the visible light range, such as ultraviolet light and infrared light. Infrared light having a wavelength range of approximately 700 nm-1 mm includes near-infrared light. In aspects of this disclosure, near-infrared light may be defined as having a wavelength range of approximately 700 nm-1.6μm.

In aspects of this disclosure, the term “transparent” may be defined as having greater than 90% transmission of light. In some aspects, the term “transparent” may be defined as a material having greater than 90% transmission of visible light.

LCOS displays may use LEDs or lasers as light sources. In order to generate a color image, red, green, and blue light sources may be illuminated sequentially while pixels of the LCOS are modulated in sync with the red, green, and blue light sources to generate red, green, and blue images that combine to generate the color images. Each red, green, or blue light source may only be illuminated for 20 ms or less to generate each sub-frame that combines into color image frame. These conventional light sources are considered “always on” light sources (at least for their given sub-frame) that contribute to higher power consumption for an LCOS display. Conventional light sources for LCOS displays also suffer from larger optical footprints to facilitate a suitable optical mixing distance for the individual light sources.

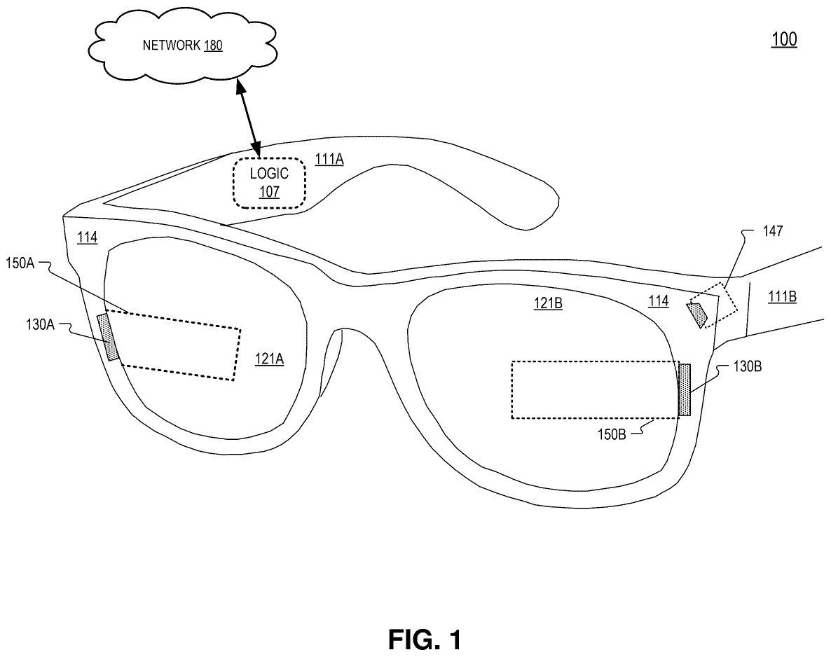

In implementations of the disclosure, a light source for a display includes an array of mini-LEDs generating illumination light and a metalens configured to focus the illumination light. The use of mini-LEDs instead of larger light sources may increase brightness uniformity and color uniformity. The metalens may have the additional benefit of significantly reducing the size of the light source and the corresponding traditional optics (e.g. refractive lenses) required for mixing distances of light sources and focusing of illumination light. The array of mini-LEDs may be selectively illuminated by a driver substrate. The array of mini-LEDs may be red, green, and blue mini-LEDs, for example. The selective illumination of different mini-LEDs may allow for local dimming of portions of the LCOS display. This may allow for improved power consumption as well as an increase in contrast ratio of the LCOS display. These and other embodiments are described in more detail in connection with FIGS. 1-8E.

FIG. 1 illustrates a head-mounted display (HMD) 100 that may include an LCOS display system including a light source, in accordance with aspects of the present disclosure. HMD 100 includes frame 114 coupled to arms 111A and 111B. Lens assemblies 121A and 121B are mounted to frame 114. Lens assemblies 121A and 121B may include a prescription lens matched to a particular user of HMD 100. The illustrated HMD 100 is configured to be worn on or about a head of a wearer of HMD 100.

In the HMD 100 illustrated in FIG. 1, each lens assembly 121A/121B includes a waveguide 150A/150B to direct image light generated by displays 130A/130B to an eyebox region for viewing by a user of HMD 100. Displays 130A/130B may include a liquid crystal on silicon (LCOS) display for directing image light to a wearer of HMD 100 to present virtual images, for example. The LCOS display may include a light source that includes mini-LEDs and a metalens.

Lens assemblies 121A and 121B may appear transparent to a user to facilitate augmented reality or mixed reality to enable a user to view scene light from the environment around them while also receiving image light directed to their eye(s) by waveguides 150, for example. Lens assemblies 121A and 121B may include two or more optical layers for different functionalities such as display, eye-tracking, and optical power. In some embodiments, display light from display 130A or 130B is only directed into one eye of the wearer of HMD 100. In an embodiment, both displays 130A and 130B are used to direct display light into waveguides 150A and 150B, respectively.

Frame 114 and arms 111 may include supporting hardware of HMD 100 such as processing logic 107, a wired and/or wireless data interface for sending and receiving data, graphic processors, and one or more memories for storing data and computer-executable instructions. Processing logic 107 may include circuitry, logic, instructions stored in a machine-readable storage medium, ASIC circuitry, FPGA circuitry, and/or one or more processors. In one embodiment, HMD 100 may be configured to receive wired power. In one embodiment, HMD 100 is configured to be powered by one or more batteries. In one embodiment, HMD 100 may be configured to receive wired data including video data via a wired communication channel. In one embodiment, HMD 100 is configured to receive wireless data including video data via a wireless communication channel. Processing logic 107 may be communicatively coupled to a network 180 to provide data to network 180 and/or access data within network 180. The communication channel between processing logic 107 and network 180 may be wired or wireless.

In the illustrated implementation of FIG. 1, HMD 100 includes a camera 147 configured to image an eyebox region. In some implementations, an illumination module (not specifically illustrated) may illuminate the eyebox region with near-infrared illumination light to assist camera 147 in imaging the eyebox region for eye-tracking purposes. Camera 147 may include a lens assembly configured to focus image light to a complementary metal-oxide semiconductor (CMOS) image sensor, in some implementations. A near-infrared filter that receives a narrow-band near-infrared wavelength may be placed over the image sensor so it is sensitive to the narrow-band near-infrared wavelength while rejecting visible light and wavelengths outside the narrow-band. Near-infrared illuminators (not illustrated) such as near-infrared LEDs or laser diodes that emit the narrow-band wavelength may be included in the illumination module to illuminate the eyebox region with the narrow-band near-infrared wavelength.

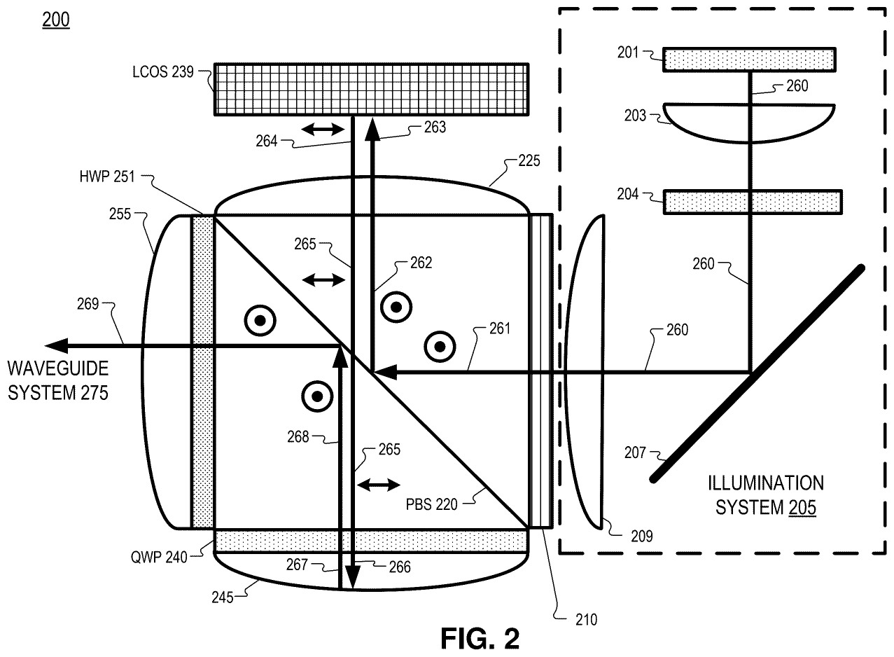

FIG. 2 illustrates an example LCOS system 200 having a conventional illumination system 205. Illumination system 205 includes a light source layer 201. Light source layer 201 may include LEDs or lasers disposed on an electronic substrate. There may be one red LED, one green LED, and one blue LED in light source layer 201, for example. There may be one red laser diode, one green laser diode, and one blue laser diode in light source layer 201, in some examples. Light source layer 201 may receive (or generate) illumination signals to sequentially turn on the red, green, and blue light sources to generate illumination light 260. Illumination system 205 includes more than one color channel so that the display light generated by LCOS system 200 includes color images. In some implementations, illumination system 205 includes red, green, and blue (RGB) light sources that emit light sequentially and the red, green, and blue portions of an image are driven onto LCOS 239 in concert with illumination system 205 sequentially emitting the red, green, and blue illumination light.

Illumination system 205 may include focusing optics 203 configured to focus illumination light 260 to mirror 207. Focusing optics 203 may include one or more refractive lenses. A polarizing element 204 may be optionally disposed between light source layer 201 and mirror 207 to polarize illumination light 260 to a particular polarization orientation. Illumination system 205 may also include focusing optics 209 to further focus illumination light 260 after illumination light 260 reflects off mirror 207 and propagates toward polarizing beam splitter (PBS) 220.

LCOS system 200 further includes a pre-polarizer 210, polarized beam splitter (PBS) 220, a lens 225, an LCOS 239, a quarter-waveplate (QWP) 240, a reflector 245, a half-waveplate (HWP) 251, a lens 255, and a waveguide system 275.

In operation, illumination light 260 is emitted from illumination system 205 and propagates along optical path 261 toward pre-polarizer 210. Pre-polarizer 210 passes a first linear polarization orientation of the light so the illumination light has a homogeneous polarization orientation. PBS 220 is configured to reflect the first linear polarization orientation and pass a second linear polarization orientation that is orthogonal to the first linear polarization orientation. Thus, the illumination light having the first linear polarization orientation reflects off PBS 220 and is redirected toward LCOS 239 along optical path 262.

Lens 225 may focus the illumination light propagating along optical path 262 to generate compensated illumination light 263 that encounters LCOS 239. Lens 225 may be a refractive lens. Lens 225 may be considered a field lens.

LCOS 239 receives compensated illumination light 263 and is configured to modulate the compensated illumination light to generate display light. Images may be driven on an LCOS pixel array of LCOS 239. The LCOS pixel array may be arranged in rows and columns and each LCOS pixel in the LCOS pixel array may be modulated to reflect light or to block light. To generate color images, a red image sub-frame, a green image sub-frame, and a green image sub-frame may be sequentially driven onto LCOS 239 (in concert with red, green, and blue illumination light from light source layer 201) to generate a color image frame. The time duration of the color image frame may be less than 50 ms. The sub-frames may be approximately a third of the time of the time duration of the color image frame. In some implementations, the time duration of the color frame is approximately 33 ms, which corresponds with a frame rate of approximately 30 Hz. In some implementations, the time duration of the color frame is approximately 16 ms, which corresponds with a frame rate of approximately 60 Hz. In some implementations, the time duration of the color frame is approximately 8 ms, which corresponds with a frame rate of approximately 120 Hz.

Display light 264 generated by LCOS 239 is received by lens 225 and exits as compensated display light 265. Compensated display light 265 may have a second linear polarization orientation orthogonal to the first linear polarization orientation of illumination light 262. Since PBS 220 is configured to pass the second linear polarization orientation and reflect the first linear polarization orientation, the compensated display light 265 (having the second linear polarization orientation) passes through PBS 220 and retains its second linear polarization orientation.

The compensated display light 265 encounters QWP 240. QWP 240 is configured to shift the polarization axis of incident light such that linearly polarized light may be converted to circularly polarized light by QWP 240. Likewise, incident circularly polarized light may be converted to linearly polarized light by QWP 240. QWP 240 may be made of birefringent materials such as quartz, organic material sheets, or liquid crystal, for example. In one embodiment, QWP 240 is designed to be a so called “zero order waveplate” so that the retardance imparted by the QWP 240 remains close to a quarter of a wave independent of the wavelength and angle of incidence of incoming light.

The compensated display light 265 having the second linear polarization is converted to circularly polarized light propagating along optical path 266 prior to encountering reflector 245. Reflector 245 may include a lensing curvature to assist in focusing the compensated display light. The circularly polarized light propagating along optical path 266 reflects off reflector 245 which changes the orientation of the light propagating along optical path 267 to the opposite-handed circularly polarized light than that of the circularly polarized light propagating along optical path 266. The light propagating along optical path 267 is then converted to linearly polarized light by QWP 240.

As shown in FIG. 2, the light propagating along optical path 268 is in the first linear polarization orientation and is reflected by PBS 220 toward waveguide system 275. Waveguides 130A/130B in FIG. 1 may be an example of waveguide system 275.

The light directed toward waveguide system 275 by PBS 220 retains its first linear polarization orientation and encounters HWP 251. HWP 251 is configured to shift the polarization axis of incident light by π/2 (90 degrees). Therefore, in some implementations, linearly polarized light may be converted by HWP 251 to an orthogonal orientation of the linearly polarized light reflecting from PBS 220 toward waveguide system 275. In other implementations, light encountering HWP 251 may be converted to a different polarization direction that is not necessarily orthogonal to the received light. HWP 251 may be designed to be a so called “zero order waveplate” so that the retardance imparted by HWP 251 remains close to half of a wave independent of the wavelength and angle of incidence of incoming light.

Waveguide system 275 is configured to receive the display light propagating along optical path 269. Waveguide system 275 may be configured to direct virtual images included in the display light to an eyebox region. The eyebox region may be the region that an eye of a user would occupy when wearing HMD 100, for example.

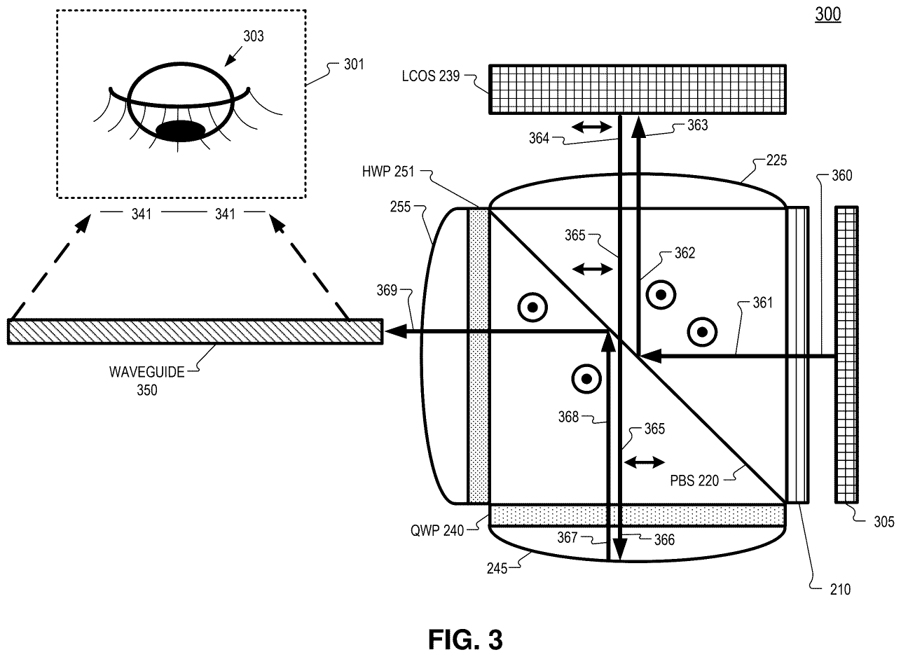

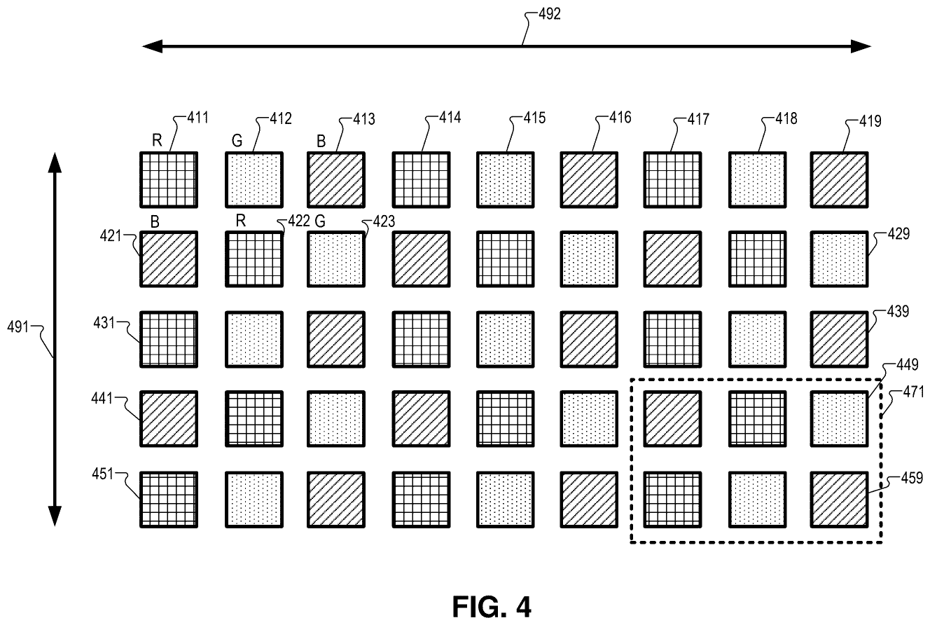

FIG. 3 illustrates an example LCOS system 300 including an illumination system 305, in accordance with aspects of the disclosure. Illumination system 305 may save significant space compared with illumination system 205 of FIG. 2. In some implementations, illumination system 305 may be packaged in a planar format using some or all of the aspects described in association with FIGS. 4-8E.

LCOS system 300 has similarities to LCOS system 200. In operation, illumination light 360 is emitted from illumination system 305 and propagates toward pre-polarizer 210. Pre-polarizer 210 passes a first linear polarization orientation of the light so the illumination light has a homogeneous polarization orientation. PBS 220 is configured to reflect the first linear polarization orientation and pass a second linear polarization orientation that is orthogonal to the first linear polarization orientation.

Thus, the illumination light having the first linear polarization orientation reflects off PBS 220 and is redirected toward LCOS 239 along optical path 362.

Lens 225 may focus the illumination light propagating along optical path 362 to generate compensated illumination light 363 that encounters LCOS 239. LCOS 239 receives compensated illumination light 363 and is configured to modulate the compensated illumination light to generate display light. Images may be driven on an LCOS pixel array of LCOS 239. The LCOS pixel array may be arranged in rows and columns and each LCOS pixel in the LCOS pixel array may be modulated to reflect light or to block light. To generate color images, a red image sub-frame, a green image sub-frame, and a green image sub-frame may be sequentially driven onto LCOS 239 (in concert with red, green, and blue illumination light from mini-LEDs in illumination system 305) to generate a color image frame. The time duration of the color image frame may be less than 50 ms. The sub-frames may be approximately a third of the time of the time duration of the color image frame. In some implementations, the time duration of the color frame is approximately 33 ms, which corresponds with a frame rate of approximately 30 Hz. In some implementations, the time duration of the color frame is approximately 16 ms, which corresponds with a frame rate of approximately 60 Hz. In some implementations, the time duration of the color frame is approximately 8 ms, which corresponds with a frame rate of approximately 120 Hz.

Display light 364 generated by LCOS 239 is received by lens 225 and exits as compensated display light 365. Compensated display light 365 may have a second linear polarization orientation orthogonal to the first linear polarization orientation of illumination light 362. Since PBS 220 is configured to pass the second linear polarization orientation and reflect the first linear polarization orientation, the compensated display light 365 (having the second linear polarization orientation) passes through PBS 220 and retains its second linear polarization orientation.

The compensated display light 365 encounters QWP 240. The compensated display light 365 having the second linear polarization is converted to circularly polarized light propagating along optical path 366 prior to encountering reflector 245. The circularly polarized light propagating along optical path 366 reflects off reflector 245 which changes the orientation of the light propagating along optical path 367 to the opposite-handed circularly polarized light than that of the circularly polarized light propagating along optical path 366. The light propagating along optical path 367 is then converted to linearly polarized light by QWP 240.

As shown in FIG. 3, the light propagating along optical path 368 is in the first linear polarization orientation and is reflected by PBS 220 toward waveguide system 350. Waveguides 130A/130B in FIG. 1 may be an example of waveguide system 350.

The light directed toward waveguide system 350 by PBS 220 retains its first linear polarization orientation and encounters HWP 251. HWP 251 is configured to shift the polarization axis of incident light by π/2 (90 degrees). Therefore, in some implementations, linearly polarized light may be converted by HWP 251 to an orthogonal orientation of the linearly polarized light reflecting from PBS 220 toward waveguide system 350. Waveguide system 350 may rely on mirrors or diffractive incoupling elements to incouple the display light into the waveguide 350. Waveguide system 350 may rely on mirrors or diffractive outcoupling elements to outcouple the display to the eyebox region 301.

Waveguide system 350 is configured to receive the display light (from the LCOS 239) propagating along optical path 369 and redirect the display light. Waveguide system 350 may be configured to direct virtual images included in the display light to eyebox region 301. Eyebox region 301 may be the region that an eye 303 of a user would occupy when wearing HMD 100, for example.

FIG. 4 illustrates an example arrangement of an array of mini-LEDs 400 included in a light source for an LCOS display, in accordance with aspects of the disclosure. The example array of mini-LEDs 400 includes a 5×9 grid totaling 45 mini-LED arranged in five rows and nine columns. In implementations, dimension 492 is less than 2 mm and dimension 491 is less than 1 mm. In implementations, dimension 492 is less than 1.5 mm and dimension 491 is less than 0.75 mm.

The top row of the array of mini-LEDs 400 includes mini-LEDs 411, 412, 413, 414, 415, 416, 417, 418, and 419, from left to right. Similarly, the second row of the array of mini-LEDs 400 includes mini-LEDs 421 through 429, from left to right. The third row (middle row) of the array of mini-LEDs 400 includes mini-LEDs 431 through 439, from left to right. The fourth row of the array of mini-LEDs 400 includes mini-LEDs 441 through 449, from left to right. The fifth row of the array of mini-LEDs 400 includes mini-LEDs 451 through 459, from left to right.

In the illustrated example of FIG. 4, the mini-LEDs are spaced equidistant apart from each other. The mini-LEDs may be spaced apart by less than 0.1 mm. In some implementations, the mini-LEDs are spaced apart by 0.05 mm or less.

FIG. 4 illustrates that the array of mini-LEDs 400 includes red mini-LEDs, green mini-LEDs, and blue mini-LEDs. For example, mini-LEDs 411, 414, 417, 422, 431, and 451 are red mini-LEDs. The red mini-LEDs in FIG. 4 are indicated by the grid pattern fill, even though each LED does not necessarily have an individual reference label. Green mini-LEDs in FIG. 4 include mini-LEDs 412, 415, 418, 423, 429, and 449. The green mini-LEDs in FIG. 4 are indicated by the speckle pattern fill, even though each LED does not necessarily have an individual reference label. Blue mini-LEDs in FIG. 4 include mini-LEDs 413, 416, 419, 421, 439, 441, and 459. The blue mini-LEDs in FIG. 4 are indicated by the diagonal pattern fill, even though each LED does not necessarily have an individual reference label.

In FIG. 4, the mini-LEDs are arranged in red, green, and blue (RGB) groupings. For example, mini-LEDs 411, 412, 413, 421, 422, and 423 may be included in a grouping. The grouping is in a pattern to assist with brightness uniformity of the illumination light emitted by an illumination system (e.g. illumination system 305).

Mini-LEDs in array 400 may be selectively illuminated. In an implementation, all of the red mini-LEDs may be selectively illuminated in a first sub-frame, all of the green mini-LEDs may be selectively illuminated in a second sub-frame, and all of the blue mini-LEDs may be selectively illuminated in a third sub-frame.

Additionally, since the mini-LEDs are selectively illuminated, zones of the mini-LEDs may be selectively illuminated to facilitate local dimming for images. FIG. 4 illustrates an example zone 471 that includes six mini-LEDs. Zone 471 includes two red mini-LEDs, two green mini-LEDs, and two blue mini-LEDs. Other zones of mini-LEDs may be smaller or larger to facilitate local dimming.

By way of illustration, when an image to be displayed by an LCOS is dark in the bottom right corner, mini-LEDs in zone 471 may not be illuminated, may be illuminated at a dimmer current level, or may be illuminated for a shorter period of their red, green, and blue sub-frames in order to facilitate local dimming zones. When an image to be displayed by an LCOS is bright in the bottom right corner, mini-LEDs in zone 471 may be illuminated at a brighter current level or may be illuminated for a longer period of their red, green, and blue sub-frames in order to facilitate local dimming zones. In this way, local brightness can be modulated which assists increasing the contrast ratio for images of the display system.

Conventional light sources may only include three light sources (e.g. LEDs or laser diodes), five light sources, or 6 light sources. In contrast, using a larger array of smaller mini-LEDs gives more design freedom to layout the mini-LEDs more evenly which may assist in brightness uniformity and assist in facilitating local dimming features of the LCOS display.

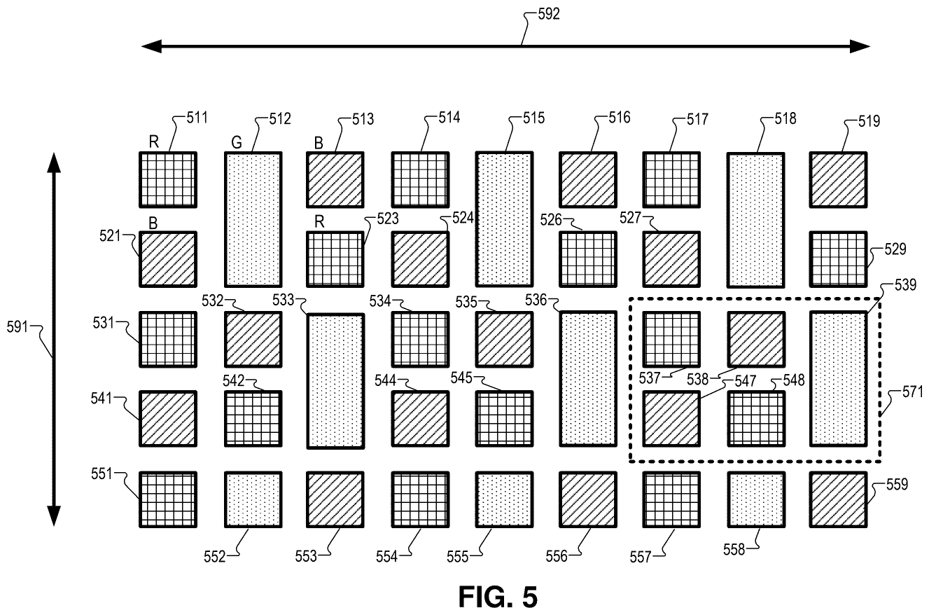

FIG. 5 illustrates an example arrangement of an array of mini-LEDs 500 included in a light source for an LCOS display, in accordance with aspects of the disclosure. The example array of mini-LEDs 500 includes 39 mini-LED. In implementations, dimension 592 is less than 2 mm and dimension 591 is less than 1 mm. In implementations, dimension 592 is less than 1.5 mm and dimension 591 is less than 0.75 mm.

The mini-LEDs in the array 500 include a first portion of green mini-LEDs and a second portion of green mini-LEDs having a larger emission area than the green mini-LEDs in the first portion. For example, the first portion of green mini-LEDs includes mini-LEDs 552, 555, and 558 and the second portion of green mini-LEDs includes mini-LEDs 512, 515, 518, 533, 536, and 539. The second portion of the green mini-LEDs have an emission area larger than red mini-LEDs and the blue mini-LED in the array 500. The emission area of the green mini-LEDs may be twice or more than the emission areas of the red mini-LEDs or the blue mini-LEDs. The first portion of the green mini-LEDs are sized similarly to red mini-LEDs in the array or blue mini-LEDs in the array, in FIG. 5.

Similar to FIG. 4, red mini-LEDs in FIG. 5 are indicated by the grid pattern fill, green mini-LEDs in FIG. 5 are indicated by the speckle pattern fill, and blue mini-LEDs in FIG. 5 are indicated by the diagonal pattern fill.

In FIG. 4, the mini-LEDs are arranged in red, green, and blue (RGB) groupings. For example, mini-LEDs 511, 512, 513, 521, and 523 may be included in a grouping. The grouping is in a pattern to assist with brightness uniformity of the illumination light emitted by an illumination system (e.g. illumination system 305).

Mini-LEDs in array 500 may be selectively illuminated. In an implementation, all of the red mini-LEDs may be selectively illuminated in a first sub-frame, all of the green mini-LEDs may be selectively illuminated in a second sub-frame, and all of the blue mini-LEDs may be selectively illuminated in a third sub-frame. Additionally, since the mini-LEDs are selectively illuminated, zones of the mini-LEDs may be selectively illuminated to facilitate local dimming for images. FIG. 5 illustrates an example zone 571 that includes five mini-LEDs. Zone 571 includes two red mini-LEDs, one green mini-LED, and two blue mini-LEDs. Other zones of mini-LEDs may be smaller or larger to facilitate local dimming.

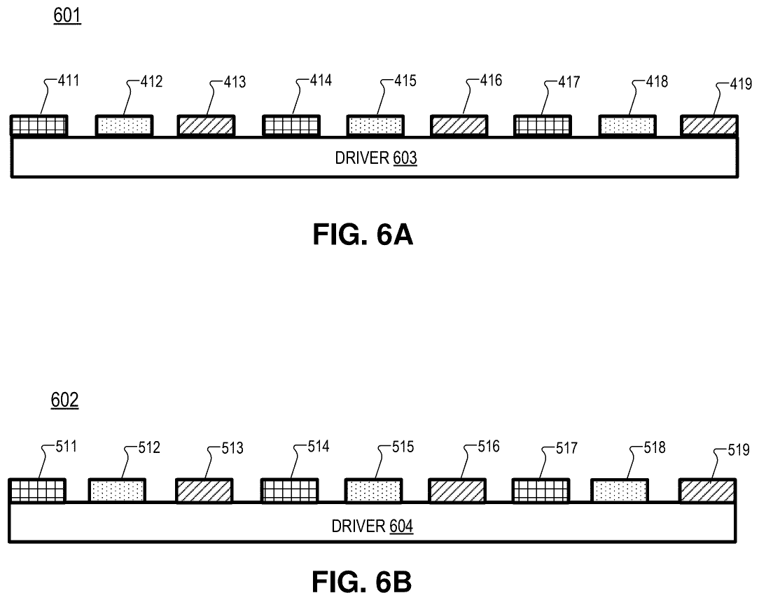

FIG. 6A illustrates a side view of a structure 601 including array 400 disposed on a driver substrate 603, in accordance with aspects of the disclosure. Driver substrate 603 may include a printed circuit board (PCB). Driver substrate 603 may include analog and/or digital circuitry to assist in driving the mini-LED in array 400. Mini-LEDs in array 400 may be electrically coupled to solder pads or traces of driver substrate 603. A pick and place (PnP) tool may be used to place mini-LEDs onto driver substrate 603, in some fabrication environments. Driver substrate 603 may include one or more heat-sinking backplanes (e.g. copper or aluminum) to sink heat from the mini-LEDs in array 400. Driver substrate 603 may be configured to selectively illuminate the mini-LEDs in array 400 to generate the illumination light. Driver substrate 603 may be configured to provide local dimming by selectively illuminating zones of the mini-LEDs in array 400.

FIG. 6B illustrates a side view of a structure 602 including array 500 disposed on a driver substrate 604, in accordance with aspects of the disclosure. Driver substrate 604 may include a printed circuit board (PCB). Driver substrate 604 may include analog and/or digital circuitry to assist in driving the mini-LED in array 500. Mini-LEDs in array 500 may be electrically coupled to solder pads or traces of driver substrate 604. A pick and place (PnP) tool may be used to place mini-LEDs onto driver substrate 604, in some fabrication environments. Driver substrate 604 may include one or more heat-sinking backplanes (e.g. copper or aluminum) to sink heat from the micro-LEDs in array 500. Driver substrate 604 may be configured to selectively illuminate the mini-LEDs in array 500 to generate the illumination light. Driver substrate 604 may be configured to provide local dimming by selectively illuminating zones of the mini-LEDs in array 500.

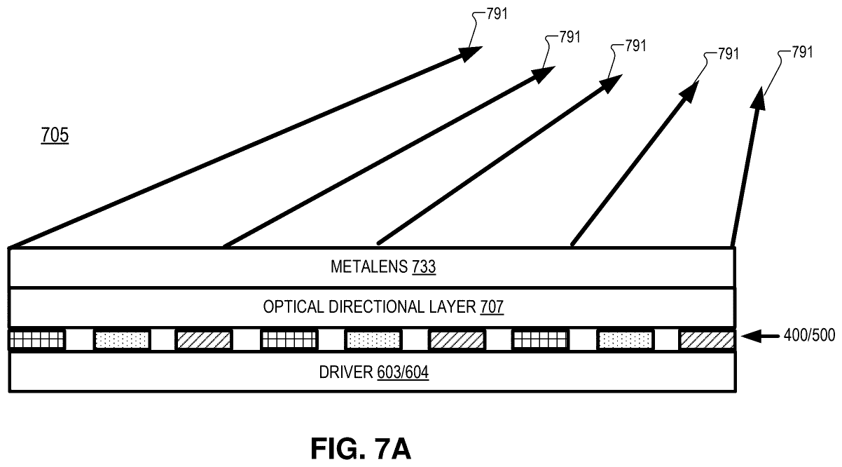

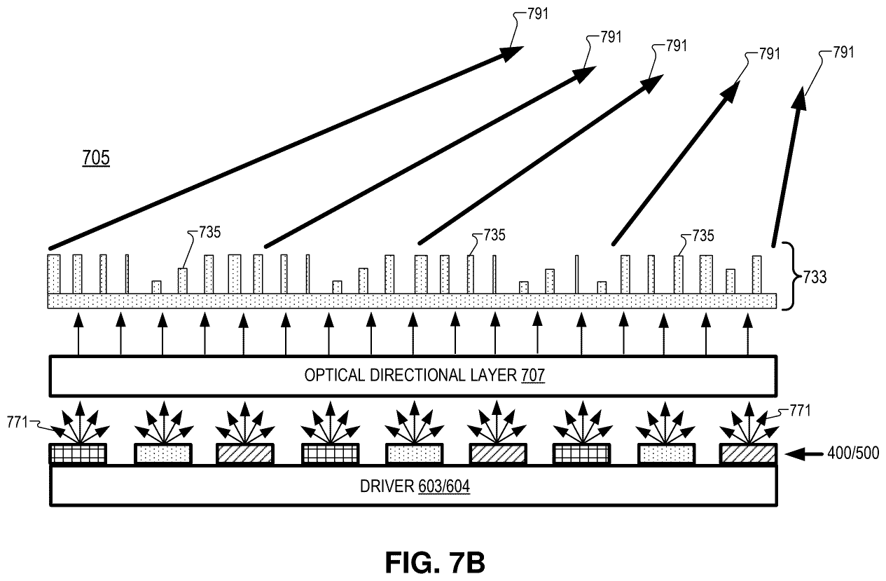

FIG. 7A illustrates an example illumination system 705 including a driver substrate 603/604, mini-LED array 400 or 500, an optional direction layer 707, and a metalens 733, in accordance with aspects of the disclosure. Metalens 733 is configured to focus illumination light generated by the mini-LEDs in array 400/500 to an LCOS display as focused illumination light 791. Focused illumination light 791 may propagate along optical path 361 in FIG. 3, for example. The LCOS display will then be able to modulate the focused illumination light 791 into display light (e.g. display light 364/369).

Metalens 733 is configured to provide positive or negative optical power to the illumination light received from the mini-LEDs to generate the focused illumination light 791, in some implementations. In some implementations, metalens 733 is configured to laterally shift the illumination light to generate the focused illumination light. Metalens 733 may provide various optical functions in addition to providing positive or negative optical power.

In FIG. 7A, optional directional layer 707 is disposed between metalens 733 and the array of mini-LEDs. FIG. 7B shows an exploded view of example illumination system 705, in accordance with aspects of the disclosure. In operation, the mini-LEDs in array 400 or 500 emit illumination light 771. Illumination light 771 may have a distribution of emission that is Lambertian, for example. Optional directional layer 707 may be configured to pre-condition illumination light 771 for encountering metalens 733. In an example, optional direction layer 707 is configured to collimate illumination light 771. Pre-conditioning illumination light 771 for metalens 733 may increase the efficiency and/or precision of metalens 733 in focusing or shifting the illumination light to generate focused illumination light 791.

In some implementations, direction layer 707 is considered a resonant layer. The resonant layer may include multiple layers of refractive materials. The layers may be different dielectrics. In an implementation, a first layer of the resonant layer includes a first refractive index and a second layer of the resonant layer includes second refractive index different from the first refractive index. The thickness of the different refractive layers are configured to generate a highly direction light emission toward metalens 733. Optional directional layer 707 may include multiple optical layers, in some implementations. Optional directional layer 707 may include a diffuser layer and/or a prism layer configured to direct the light in a specific direction.

The illustration of FIG. 7B shows that metalens 733 includes sub-wavelength nanostructures 735. The nanostructures 735 of metalens 733 are sub-wavelength in that the nanostructures have smaller dimensions than the wavelength of light that the metalens is designed to operate on. For example, if metalens is configured to focus green light having a wavelength of 550 nm, nanostructures 735 would have dimension smaller than 550 nm. The nanostructures 735 may be cylindrical, in some implementations. Nanostructure 735 can have a variety of different shapes, in different implementations.

Patterns written into nanostructures 735 allow the metalens 733 to focus and/or shift incident light in variety of optical functions. A height or width of the nanostructures 735 may be different to achieve various optical functions, for example.

While metalens 733 and nanostructures 735 may be made from refractive materials (e.g. silicon, silicon-nitride, or titanium-oxide) the optical power of metalens is not derived from refractive optical power. Rather, the optical functionality (including optical power) of metalens 733 is generated by the nanostructures 735 inducing phase differences in incident light. Since metalenses can focus and redirect light using sub-wavelength nanostructures, they can be incredibly flat and thin compared to conventional refractive optical lenses.

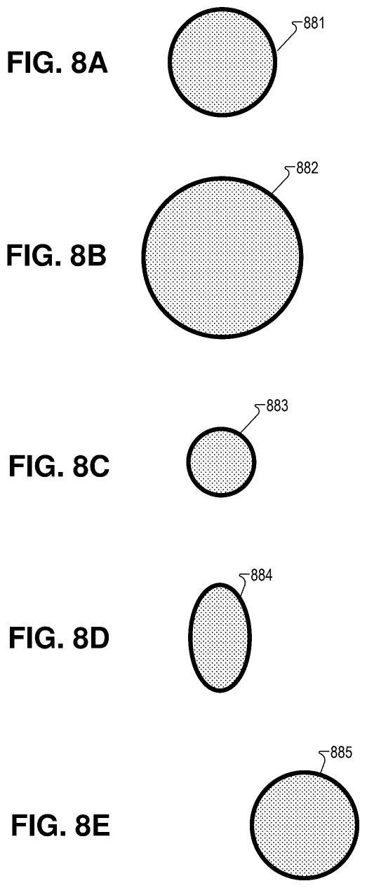

FIGS. 8A-8E show example optical functionality that may be written into metalens 733, in accordance with aspects of the disclosure. FIG. 8A shows an example original wavefront 881 encountering a metalens. FIG. 8B shows that a metalens can defocus the original wavefront 881 into defocused wavefront 882. FIG. 8C shows that a metalens can focus the original wavefront 881 into focused wavefront 883. FIG. 8D shows that a metalens can modify the original wavefront 881 into astigmatism wavefront 884. FIG. 8E shows that a metalens can laterally shift the original wavefront 881 into shifted wavefront 885. FIGS. 8B-8E are merely examples of metalens functionality and those skilled in the art appreciate that a metalens can be designed to provide additional optical functionality than is illustrated. Additionally, a metalens (including metalens 733) may be configured to provide optical functionalities that combine the optical functionalities illustrated in FIGS. 8B-8E. For example, metalens 733 may focus illumination light in addition to laterally shifting the illumination light.

“Writing” optical functions into metalens 733 allows for eliminating or reducing bulky optical element(s) (e.g. 203 and/or 209) in illumination system 205, for example. This greatly shrinks the size of an LCOS system, which may be particularly important to reduce size and weight in the context of a head-mounted display (HMD) such as AR glasses.

Yet another potential advantage of metalenses is that metalenses may be fabricated in a Complimentary Metal-Oxide-Semiconductor (CMOS) process. For example, a CMOS process may etch a refractive material (silicon, silicon-nitride, or titanium-oxide) to form nanostructures 735 that provide the optical functionality of metalens 733. In some implementations, directional layer 707 and metalens 733 are formed by CMOS processes.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

The term “processing logic” (e.g. processing logic 107) in this disclosure may include one or more processors, microprocessors, multi-core processors, Application-specific integrated circuits (ASIC), and/or Field Programmable Gate Arrays (FPGAs) to execute operations disclosed herein. In some embodiments, memories (not illustrated) are integrated into the processing logic to store instructions to execute operations and/or store data. Processing logic may also include analog or digital circuitry to perform the operations in accordance with embodiments of the disclosure.

A “memory” or “memories” described in this disclosure may include one or more volatile or non-volatile memory architectures. The “memory” or “memories” may be removable and non-removable media implemented in any method or technology for storage of information such as computer-readable instructions, data structures, program modules, or other data. Example memory technologies may include RAM, ROM, EEPROM, flash memory, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device.

Networks may include any network or network system such as, but not limited to, the following: a peer-to-peer network; a Local Area Network (LAN); a Wide Area Network (WAN); a public network, such as the Internet; a private network; a cellular network; a wireless network; a wired network; a wireless and wired combination network; and a satellite network.

Communication channels may include or be routed through one or more wired or wireless communication utilizing IEEE 802.11 protocols, short-range wireless protocols, SPI (Serial Peripheral Interface), I²C (Inter-Integrated Circuit), USB (Universal Serial Port), CAN (Controller Area Network), cellular data protocols (e.g. 3G, 4G, LTE, 5G), optical communication networks, Internet Service Providers (ISPs), a peer-to-peer network, a Local Area Network (LAN), a Wide Area Network (WAN), a public network (e.g. “the Internet”), a private network, a satellite network, or otherwise.

A computing device may include a desktop computer, a laptop computer, a tablet, a phablet, a smartphone, a feature phone, a server computer, or otherwise. A server computer may be located remotely in a data center or be stored locally.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible non-transitory machine-readable storage medium includes any mechanism that provides (i.e., stores) information in a form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A display system comprising:
an array of mini-LEDs configured to generate illumination light;
a Liquid Crystal on Silicon (LCOS) display; and
a metalens configured to focus the illumination light to the LCOS display as focused illumination light, wherein the LCOS display is configured to modulate the focused illumination light into display light.

2. The display system of claim 1, wherein the metalens is configured to provide positive or negative optical power to the illumination light to generate the focused illumination light.

3. The display system of claim 1, wherein the metalens is configured to laterally shift the illumination light to generate the focused illumination light.

4. The display system of claim 1 further comprising:
a driver substrate configured to selectively illuminate the mini-LEDs in the array to generate the illumination light, wherein the mini-LEDs are disposed on the driver substrate, and wherein the driver substrate is configured to provide local dimming by selectively illuminating zones of the mini-LEDs.

5. The display system of claim 1, wherein the mini-LEDs are arranged in red, green, and blue (RGB) groupings.

6. The display system of claim 1, wherein the mini-LEDs in the array include a first portion of green mini-LEDs and a second portion of green mini-LEDs, and wherein the second portion of the green mini-LEDs have an emission area larger than red mini-LEDs in the array, and further wherein the second portion of the green mini-LEDs have an emission area larger than blue mini-LEDs in the array.

7. The display system of claim 6, wherein the first portion of the green mini-LEDs are sized similarly to red mini-LEDs in the array or blue mini-LEDs in the array.

8. The display system of claim 1 further comprising:
a waveguide configured to receive the display light from the LCOS display and redirect the display light.

9. The display system of claim 8 further comprising:
a polarized beam splitter (PBS) optically coupled between the LCOS display and the waveguide, wherein the display light is directed to the waveguide by the PBS.

10. The display system of claim 1 further comprising:
a resonant layer disposed between the array of mini-LEDs and the metalens, wherein the resonant layer is configured to collimate the illumination light for the metalens.

11. The display system of claim 10, wherein the resonant layer includes a first layer including a first refractive index and a second layer including a second refractive index different from the first refractive index.

12. The display system of claim 10 further comprising:
a driver substrate configured to selectively illuminate the mini-LEDs in the array to generate the illumination light, wherein the mini-LEDs are disposed on the driver substrate, and wherein the driver substrate is a Complimentary Metal-Oxide-Semiconductor (CMOS) driver substrate, the resonant layer and the metalens formed by CMOS processes.

13. A light source for a display comprising:
a driver substrate;
an array of mini-LEDs electrically coupled to the driver substrate, wherein the driver substrate is configured to selectively illuminate mini-LEDs in the array to generate illumination light; and
a metalens configured to focus the illumination light as focused illumination light.

14. The light source of claim 13, wherein the metalens is configured to provide positive or negative optical power to the illumination light to generate the focused illumination light.

15. The light source of claim 13, wherein the metalens is configured to laterally shift the illumination light to generate the focused illumination light.

16. The light source of claim 13, wherein the driver substrate is configured to provide local dimming by selectively illuminating zones of the mini-LEDs.

17. The light source of claim 13, wherein the mini-LEDs are arranged in red, green, and blue (RGB) groupings.

18. The light source of claim 17, wherein the array of mini-LEDs includes at least ten red mini-LEDs and at least ten blue min-LEDs.

19. The light source of claim 13 further comprising:
a resonant layer disposed between the array of mini-LEDs and the metalens, wherein the resonant layer is configured to collimate the illumination light for the metalens, and wherein the resonant layer includes a first layer including a first refractive index and a second layer including a second refractive index different from the first refractive index.

20. A head-mounted display (HMD) comprising:
a driver substrate;
an array of mini-LEDs, wherein the driver substrate is configured to selectively illuminate mini-LEDs in the array to generate illumination light;
a Liquid Crystal on Silicon (LCOS) display;
a metalens configured to focus the illumination light to the LCOS display as focused illumination light; and
a waveguide, wherein the LCOS display is configured to modulate the focused illumination light into display light, and wherein the waveguide directs the display light to an eyebox region of the head-mounted display.
